(19) United States
(12) Patent Application Publication
(10) Pub. No.: US 2014/0175789 A1
(43) Pub. Date: Jun. 26, 2014

(54) INSULATED TUBING FOR DOWNHOLE APPLICATIONS

(71) Applicants: John Arthur, Calgary (CA); Denis Gilbert, Calgary (CA); Arnoud Struyk, Calgary (CA)

(72) Inventors: John Arthur, Calgary (CA); Denis Gilbert, Calgary (CA); Arnoud Struyk, Calgary (CA)

(21) Appl. No.: 14/135,360

(22) Filed: Dec. 19, 2013

Related U.S. Application Data
(60) Provisional application No. 61/740,330, filed on Dec. 20, 2012.

(51) Int. Cl. F16L 59/15

(52) U.S. Cl. CPC F16L 59/15
USPC 285/47

(57) ABSTRACT

An insulated tubing member of an insulated tubing string includes inner and outer tubing. Solid insulating material is provided in an annular cavity between the inner and outer tubing and a slip joint is provided between adjacent insulated tubing members to accommodate differential expansion of the inner and outer tubing.

### TECHNICAL FIELD

Heavy oil from oil sands may be recovered using a thermal in-situ recovery process, such as: steam-assisted gravity drainage (SAGD), expanding solvent steam-assisted gravity drainage (ES-SAGD), cyclic steam stimulation (CSS), steamflooding, solvent-assisted cyclic steam stimulation, toe-to-heel air injection (THAI), or a solvent aided process (SAP). The present application relates to insulated tubing for use in downhole applications associated with such aforementioned recovery processes.

### BACKGROUND

In, for example, steam-assisted gravity drainage (SAGD), insulated tubing is often used in order to minimize heat loss to the overburden. Insulated tubing of the prior art generally includes an insulating medium, such as inert gas or a vacuum, for example, that is sealed between inner and outer tubing.

When installed, steam flows through the inner tubing of the insulated tubing within a steam injection well. The inner tubing and the outer tubing are at different temperatures; therefore, thermal expansion of the inner tubing is greater than thermal expansion of the outer tubing. Because the inner and outer tubing are typically welded to one another, the differential expansion may cause one or both of the inner and outer tubing to fracture or may cause the joint between the inner tubing and the outer tubing to fail. When the seal between the inner and outer tubing is compromised, the insulating medium is no longer effective.

Improved insulated tubing is, therefore, desirable.

### SUMMARY

In an aspect of the present invention, there is provided an insulated tubing member comprising: an inner tubing received in an outer tubing, the inner tubing coupled to the outer tubing by an upstream fitting located at an upstream end of the insulated tubing member and a downstream fitting located at a downstream end of the insulated tubing member; insulating material received in an annular cavity delimited by the inner tubing, the outer tubing, the upstream fitting and the downstream fitting; a slip joint between the inner tubing and the outer tubing to allow for axial movement of the inner tubing relative to the outer tubing; and wherein the axial movement is due to thermal expansion.

### DRAWINGS

The following figures set forth embodiments of the invention in which like reference numerals denote like parts. Embodiments of the invention are illustrated by way of example and not by way of limitation in the accompanying figures.

FIG. 1 is a side view of an insulated tubing string including insulated tubing members according to an embodiment;

FIG. 2 is a schematic side view of a SAGD well;

FIG. 3 is a cross-sectional view on 3-3 of FIG. 1;

FIG. 4 is an isometric view of an upstream end of the insulated tubing member;

FIG. 5 is an isometric view of a downstream end of an insulated tubing member;

FIG. 6 is an isometric view of an insulated tubing member according to another embodiment;

FIG. 7A is side view of the insulated tubing member of FIG. 6;

FIG. 7B is a view on 7B-7B of FIG. 7A;

FIG. 8A is an isometric view of an inner tubing of the insulated tubing member of FIG. 6;

FIG. 8B is a side view of FIG. 8A;

FIG. 9A is an isometric view of an upstream fitting of the insulated tubing member of FIG. 6;

FIG. 9B is a side view of FIG. 9A;

FIG. 10A is an isometric view of a downstream fitting of the insulated tubing member of FIG. 6;

FIG. 10B is a side view of FIG. 10A;

FIG. 11A is an exploded isometric view showing an upstream sleeve, an outer tubing and a downstream sleeve of the insulated tubing member of FIG. 6;

FIG. 11B is a side view of FIG. 11A;

FIG. 12A is an isometric view of a joint cover sub-assembly of the insulated tubing member of FIG. 6;

FIG. 12B is a side sectional view of FIG. 12A;

FIG. 13 is an isometric view of an outer cover of the joint cover sub-assembly of the insulated tubing member of FIG. 6;

FIG. 14A is an isometric view of a first insert of the joint cover sub-assembly of the insulated tubing member of FIG. 6;

FIG. 14B is an end view of FIG. 14A;

FIG. 15A is an isometric view of a second insert of the joint cover sub-assembly of the insulated tubing member of FIG. 6;

FIG. 15B is an end view of FIG. 15A; and

FIG. 16 is a graph showing cumulative oil and steam for test wells.

### DETAILED DESCRIPTION OF EMBODIMENTS

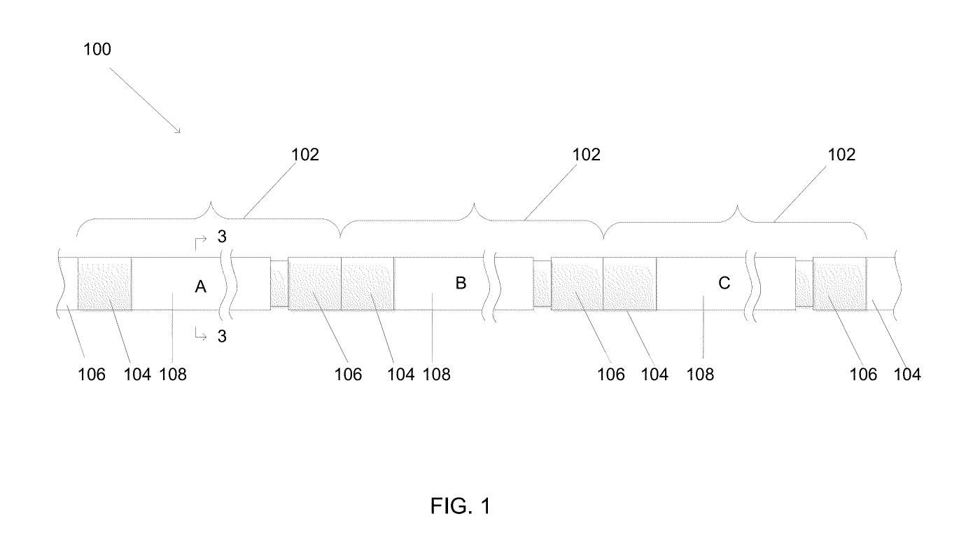

Referring to FIG. 1, an insulated tubing string 100 is generally shown. The insulated tubing string 100 includes a plurality of insulated tubing members 102 that are coupled to one another in an end-to-end arrangement.

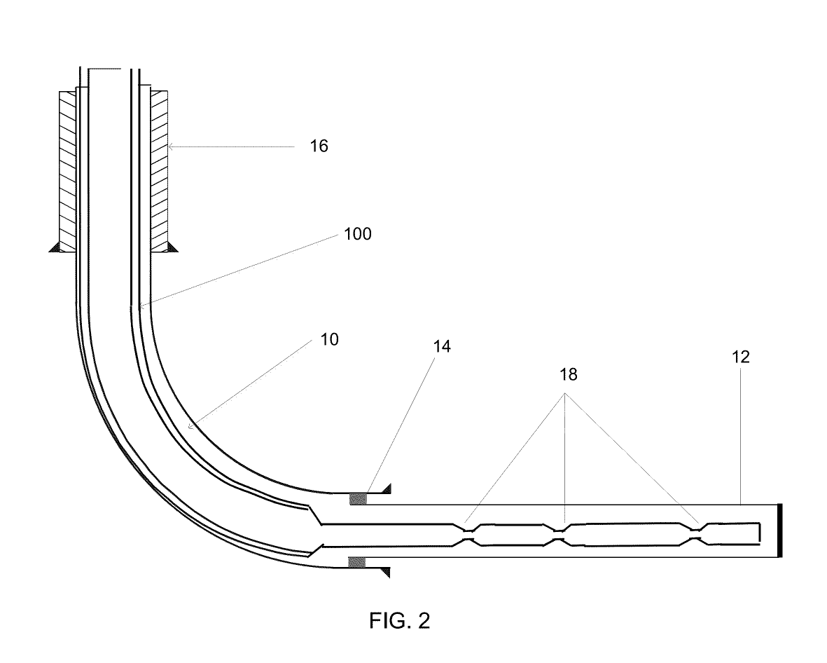

In SAGD applications, the number of insulated tubing members 102 in an insulated tubing string 100 is determined based on both the length of the individual insulated tubing members 102 and the distance from the surface to the landing of the steam injection well. As shown in FIG. 2, an insulated tubing string 100 that is received in an example SAGD steam injection well 10 extends through a surface casing 16 downhole to a horizontal section of the well 10. A liner 12, which is held in place by liner hangers 14, is located in the horizontal section of the well 10. Steam from the insulated tubing string 100 is injected into a sand face through steam subs 18.

In one example of a SAGD application, the length of one insulated tubing member 102 is approximately 13 m and the length of the insulated tubing string 100 is between approximately 500 m and approximately 1000 m. Other lengths of insulated tubing members 102 and insulated tubing strings 100 are possible as will be apparent to a person skilled in the art.

Referring again to FIG. 1, the insulated tubing members 102 include upstream fittings 104 provided at upstream ends thereof and downstream fittings 106 provided at downstream ends thereof. For the purpose of explanation, three consecutive insulated tubing members 102 are identified as A, B and C, in FIG. 1 with A being the upstream-most insulated tubing member 102 and C being the downstream-most insulated tubing member 102. As shown, the upstream fitting 104 of B mates with the downstream fitting 106 of A and the downstream fitting 106 of B mates with the upstream fitting 104 of C.

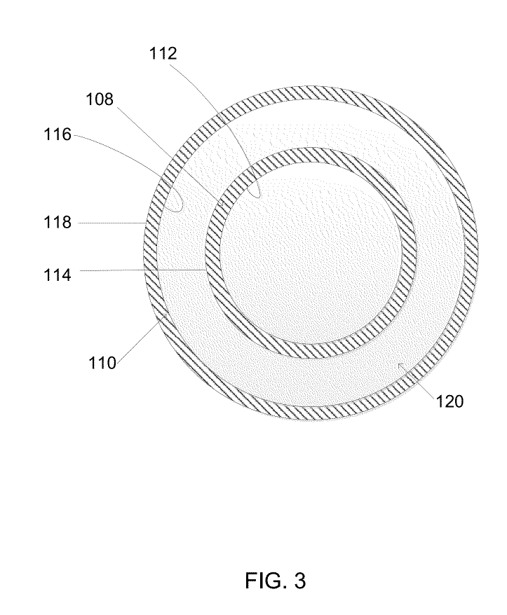

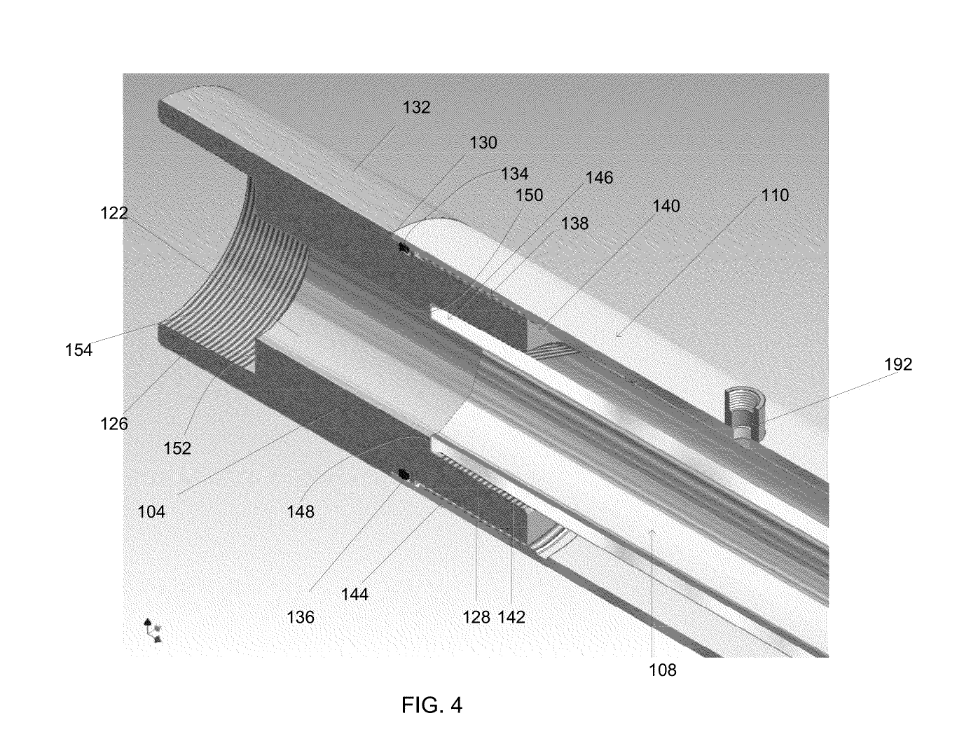

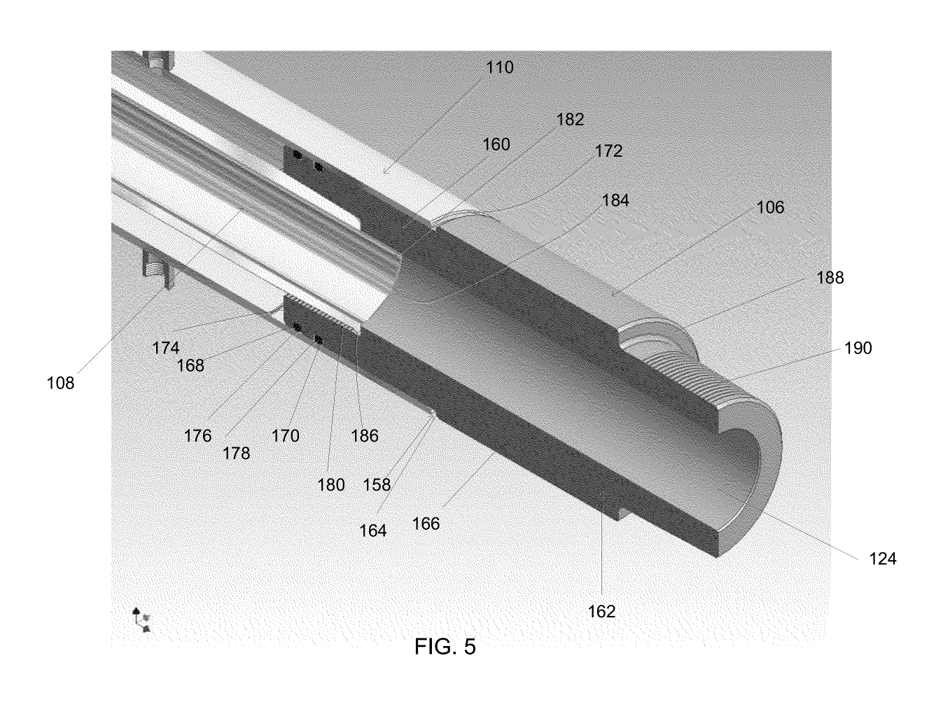

With reference to FIGS. 3, 4 and 5, a single insulated tubing member 102 will now be described. The insulated tubing member 102 includes a length of inner tubing 108 that is received inside a length of outer tubing 110, as shown in FIG. 3. The inner tubing 108 includes an inner surface 112 and an outer surface 114. The outer tubing 110 includes an inner surface 116 and an outer surface 118. An annular cavity 120 is located between the inner tubing 108 and the outer tubing 110. The upstream and downstream fittings 104 and 106 include inner surfaces 122 and 124, respectively (shown in FIGS. 4 and 5). The inner surfaces 122, 124 are generally flush with the inner surface 112 of the inner tubing 108 in order to provide a continuous, smooth channel through which steam travels.

As will be understood by a person skilled in the art, various tubing sizes are possible. In general, tubing sizes are determined based on well geometry including well diameter and steam mass flow rate requirements, for example. Structural criteria such as the overall weight of the insulated tubing string 100 and forces applied during installation and removal of the insulated tubing string 100, for example, are also considered.

Referring to FIG. 4, the upstream fitting 104 includes an upstream end 126 having a first diameter and a downstream end 128 having a second, smaller, diameter. A step 130 is formed in an outer surface 132 of the upstream fitting 104 to provide a transition between the first diameter and the second diameter.

The downstream end 128 includes a channel 134 that is formed in the outer surface 132. A seal 136 is located in the channel 134. External threads 138 are provided between the channel 134 and a downstream end surface 140 of the upstream fitting 104. The external threads 138 mate with a threaded upstream end 144 of the outer tubing 110. An outer diameter of the outer tubing 110 is sized to generally match the first diameter of the upstream fitting 104 so that the outer surface 132 of the upstream end 126 and the outer surface 118 of the outer tubing 110 are generally flush.

The downstream end 128 of the upstream fitting 104 further includes internal threads 142 for mating with a threaded upstream end 146 of the inner tubing 108. When the inner tubing 108 is fully received in the upstream fitting 104, an upstream end surface 148 of the inner tubing 108 abuts a downstream seat 150 of the upstream fitting 104. The upstream end 126 includes a seat 152 and internal threads 154 for mating with a downstream end 162 of a downstream fitting 106 of an adjacent insulated tubing member 102.

Openings 192 are provided for insertion of sensing or testing equipment, such as thermocouples, for the purpose of above-ground testing. The openings 192 are not included in production model insulated tubing members 102 for downhole deployment.

Referring to FIG. 5, the downstream fitting 106 includes an upstream end 160 having a first diameter and a downstream end 162 having a second, larger, diameter. A step 164 is formed in an outer surface 166 of the downstream fitting 106 to provide a transition between the first diameter and the second diameter.

The upstream end 160 includes a pair of channels 168, 170 that are formed in the outer surface 166 of the downstream fitting 106 proximate an upstream end surface 174. Seals 176, 178 are located in the channels 168, 170. An outer diameter of the outer tubing 110 is sized to generally match the second diameter of the downstream fitting 106 so that the outer surface 166 of the downstream end 162 and the outer surface 118 of the outer tubing 110 are generally flush. The outer tubing 110 is slidable relative to the outer surface 166 of the downstream fitting 106 so that when the inner tubing 108 lengthens due to thermal expansion, the downstream fitting 106 slides relative to the outer tubing 110.

A gap 158 is provided between a downstream end surface 172 of the outer tubing 110 and the step 164. The gap 158 is provided to accommodate tolerances and is typically approximately 6.35 mm or greater.

The upstream end 160 of the downstream fitting 106 further includes internal threads 180 that mate with a threaded downstream end 182 of the inner tubing 108.

When the inner tubing 108 is fully received in the downstream fitting 106, a downstream end surface 184 of the inner tubing 108 abuts an upstream seat 186 of the downstream fitting 106.

The downstream end 162 includes a seat 188 and external threads 190 for mating with an upstream end 126 of an upstream fitting 104 of an adjacent insulated tubing member 102.

The annular cavity 120 of the insulated tubing member 102 is delimited by the outer surface 114 of the inner tubing 108, the inner surface 116 of the outer tubing 110, the downstream end surface 140 of the upstream fitting 104 and the upstream end surface 174 of the downstream fitting 106. The annular cavity 120 is sealed and filled with insulation in order to reduce heat loss from the inner tubing 108. In one example, an insulating material is a solid insulating material such as Insulfrax™, Aspen Aerogel Pyrogel XT™, or Cabot Nanogel™, for example. Alternatively, the annular cavity 120 may be filled with a fluid, such as an inert gas, for example.

The upstream and downstream fittings 104, 106 are machined from steel; however, other suitable materials and manufacturing processes will be apparent to a person skilled in the art.

In order to assemble the insulated tubing string 100, a selected number of insulated tubing members 102 are arranged end-to-end and upstream fittings 104 are coupled to adjacent downstream fittings 106. Together, the upstream fittings 104 and the downstream fittings 106 function as a coupling to join adjacent lengths of insulated tubing. The first insulated tubing member 102 of the insulated tubing string 100 includes an attachment to a steam injection source in place of an upstream fitting 104. Similarly, the last insulated tubing member 102 in the insulated tubing string 100 includes an attachment to a non-insulated tubing section to provide steam for injection into the horizontal section of the well through steam subs, an open toe of a horizontal injection liner, or some other flow control device or method.

In operation, steam is injected into the insulated tubing string 100 in order to supply steam into a reservoir. The heat from the steam causes the inner tubing 108 of the insulated tubing members 102 to thermally expand. As the inner tubing 108 lengthens due to the thermal expansion, the downstream fittings 106 are pushed in a downstream direction and the outer surfaces 166 of the downstream fittings 106 slide relative to the inner surfaces 116 of the outer tubing 110. The size of the gap 158 increases as the downstream fitting 106 is pushed downstream. As such, the overall length of the insulated tubing string 100 increases during operation. Following operation, when the insulated tubing string 100 has cooled, the inner tubing 108 returns to a pre-expanded length.

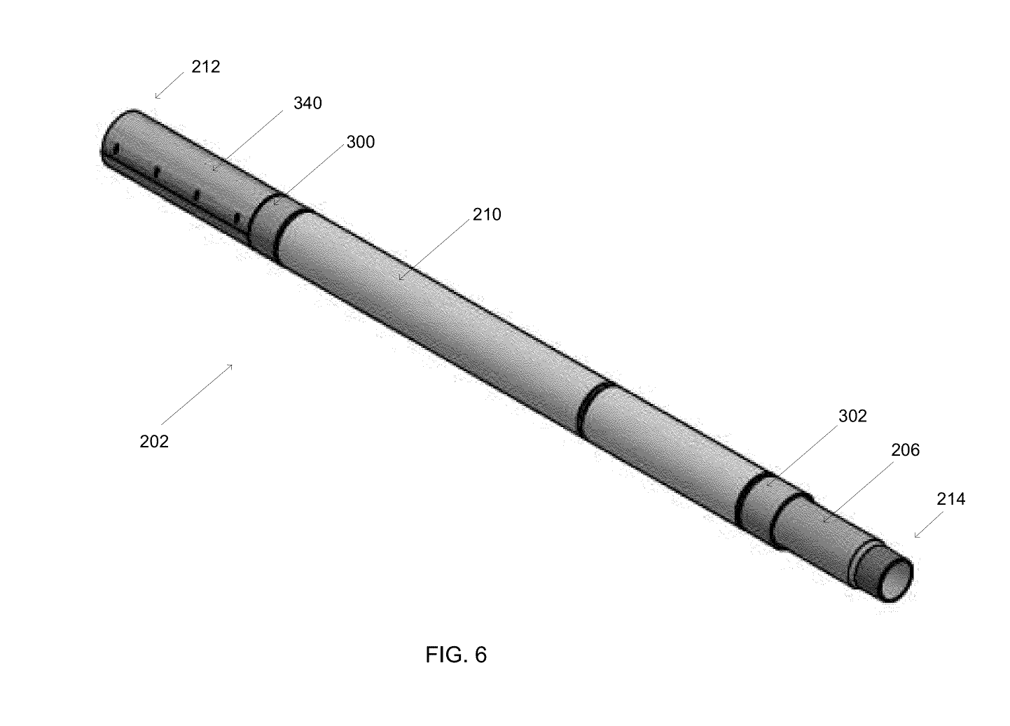

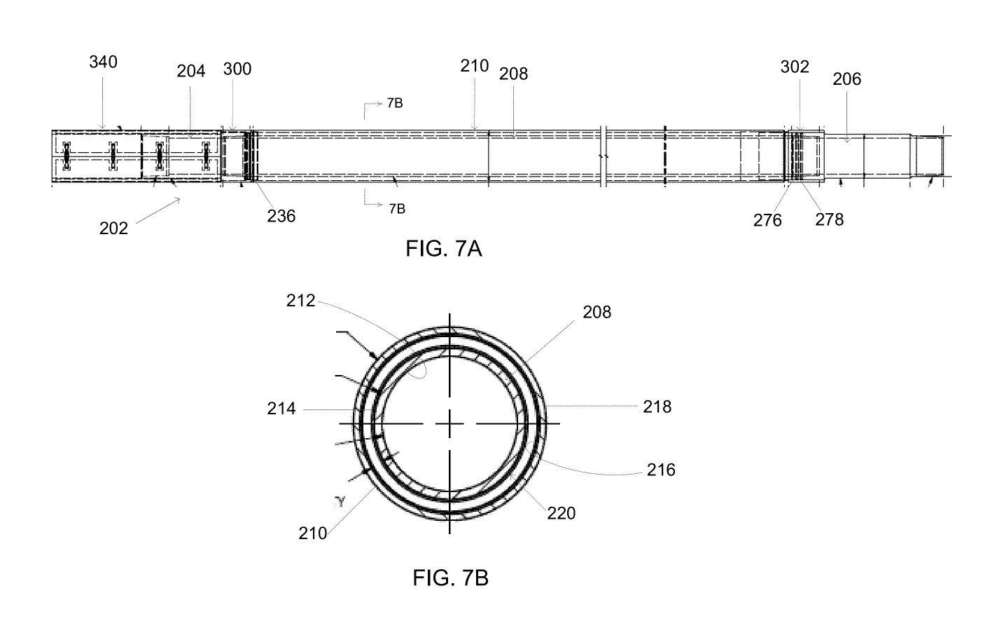

Referring to FIG. 6, an insulated tubing member 202 according to another embodiment is shown. The insulated tubing member 202 is for coupling end-to-end with other insulated tubing members 202 to form an insulated tubing string. Referring also to FIG. 7A, the insulated tubing member 202 includes a length of inner tubing 208 that is received inside a length of outer tubing 210. The inner tubing 208 includes an inner surface 212 and an outer surface 214 and the outer tubing 210 includes an inner surface 216 and an outer surface 218, as shown in FIG. 7B. An annular cavity 220 is located between the inner tubing 208 and the outer tubing 210. An upstream fitting 204 is located at an upstream end of the insulated tubing member 202 and a downstream fitting 206 is located at a downstream end of the insulated tubing member 202. The insulated tubing member 202 further includes a joint cover 340 that straddles adjacent insulated tubing members 202 to provide additional insulation and generally prevent heat loss at the joint. As shown, the joint cover is received over a portion of both the upstream fitting 204 and the downstream fitting 206 and abuts an upstream sleeve 300 and a downstream sleeve 302.

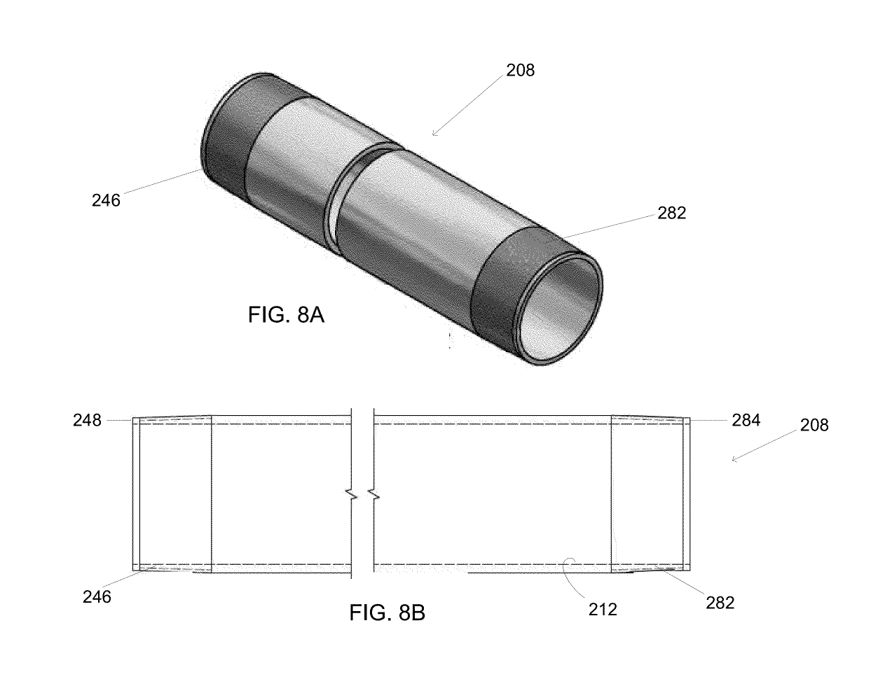

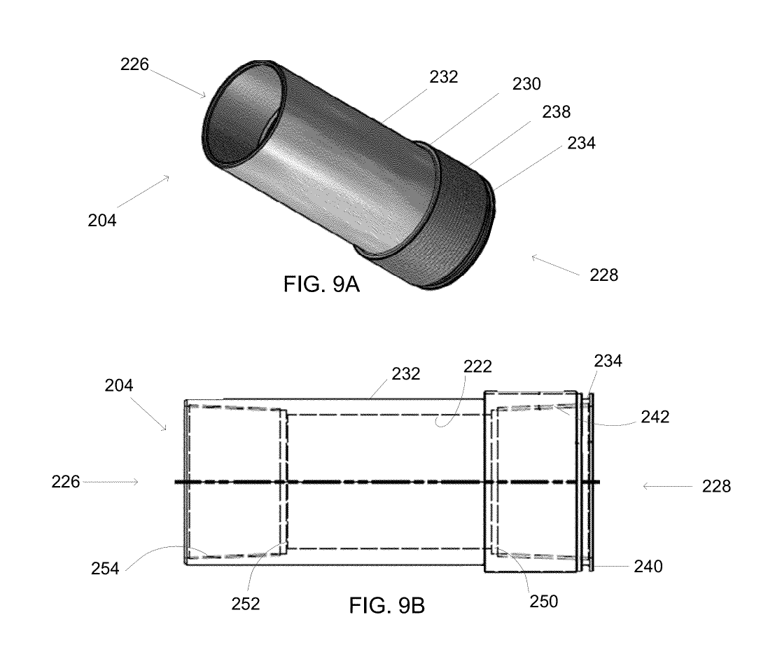

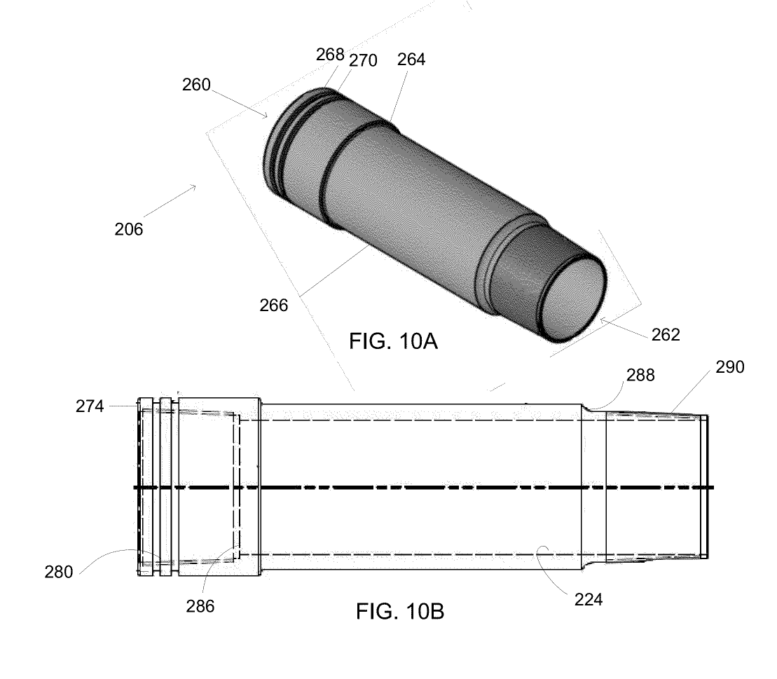

Referring also to FIGS. 8A and 8B, the inner tubing 208 includes a first threaded end 246 for mating with the upstream fitting 204 and a second threaded end 282 for mating with the downstream fitting 206. As shown in FIGS. 9A-10B, the upstream and downstream fittings 204 and 206 include inner surfaces 222 and 224, respectively. Similar to the embodiment of FIGS. 1-5, the inner surfaces 222, 224 are generally flush with the inner surface 212 of the inner tubing 208 in order to provide a continuous, smooth channel through which steam travels.

The upstream fitting 204 includes an upstream end 226 having a first diameter and a downstream end 228 having a second diameter. A step 230 is formed in an outer surface 232 of the upstream fitting 204 to provide a transition between the first diameter and the second diameter.

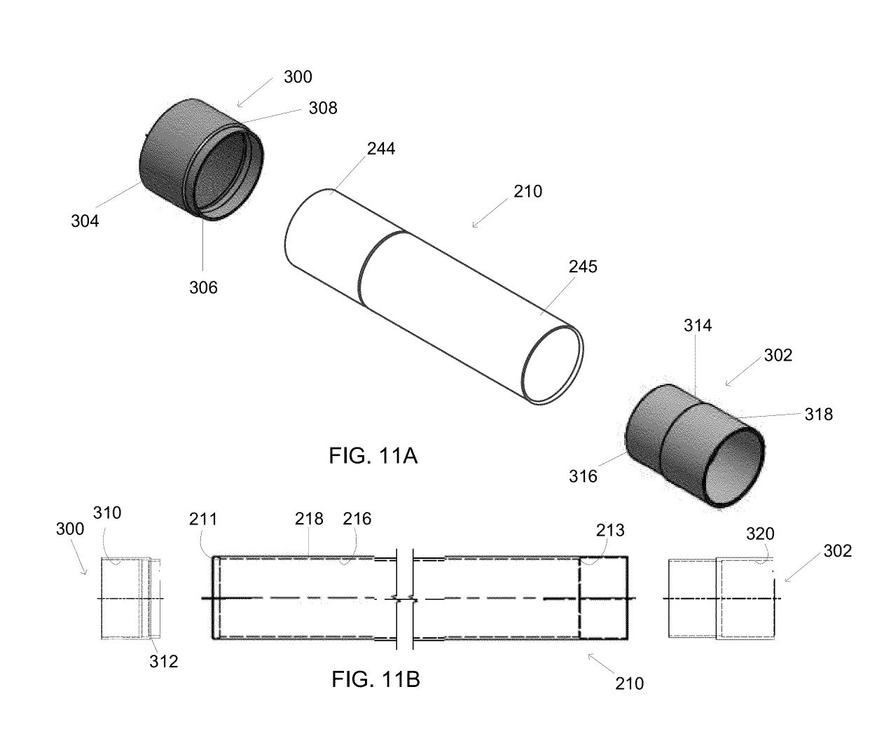

The downstream end 228 includes a channel 234 that is formed in the outer surface 232. A seal 236 (shown in FIG. 7A) is located in the channel 234. External threads 238 are provided between the channel 234 and the step 230 of the upstream fitting 204. The external threads 238 mate with a threaded inner surface 310 of the upstream sleeve 300, which is shown in FIG. 11A and 11B.

The downstream end 228 of the upstream fitting 204 further includes a threaded internal surface 242 for mating with the threaded upstream end 246 of the inner tubing 208. When the inner tubing 208 is fully received in the upstream fitting 204, an upstream end surface 248 of the inner tubing 208 abuts a downstream seat 250 of the upstream fitting 204. The upstream end 226 includes a seat 252 and internal threads 254 for mating with a downstream end 262 of a downstream fitting 206 of an adjacent insulated tubing member 202.

Referring to FIGS. 10A and 10B, the downstream fitting 206 includes an upstream end 260 having a first diameter and a downstream end 262 having a second diameter. A step 264 is formed in an outer surface 266 of the downstream fitting 206 to provide a transition between the first diameter and the second diameter. The upstream end 260 includes a pair of channels 268, 270 that are formed in the outer surface 266 of the downstream fitting 206 proximate an upstream end surface 274. Seals 276, 278 (shown in FIG. 7A) are located in the channels 268, 270.

The upstream end 260 of the downstream fitting 206 further includes internal threads 280 that mate with the second end 282 of the inner tubing 208. When the inner tubing 208 is fully received in the downstream fitting 206, a downstream end surface 284 of the inner tubing 208 abuts an upstream seat 286 of the downstream fitting 206. The downstream end 262 includes a seat 288 and external threads 290 for mating with an upstream end 226 of an upstream fitting 204 of an adjacent insulated tubing member 202.

Referring to FIGS. 11A and 11B, the upstream sleeve 300 includes a step 308 provided between an upstream portion 304 and a downstream portion 306 thereof. The upstream portion 304 includes the threaded internal surface 310, which mates with the external threads 238 of the upstream fitting 204. The downstream portion 306 is sized to be received inside an upstream end 244 of the outer tubing 210. An upstream end surface 211 of the outer tubing 210 abuts a seat 312 formed by the step 308.

The downstream sleeve 302 also includes a step 314 provided between an upstream portion 316 and a downstream portion 318 thereof. The upstream portion 316 is sized to be received inside a downstream end 245 of outer tubing 210. An upstream seat 213 of the outer tubing 210 abuts the step 314. The downstream end 318 of the downstream sleeve 302 is sized to receive the upstream end 260 of the downstream fitting 206. The seals 276, 278 are compressed between the channels 268, 270 and an inner surface 320 of the downstream end 318.

Outer diameters of the upstream end 304 of the upstream sleeve 300 and the downstream end 318 of the downstream sleeve 302 are sized to generally match an outer diameter of the outer tubing 210 so that the outer surface 218 and the outer surfaces of the upstream end 304 of the upstream sleeve 300 and the downstream end 318 of the downstream sleeve 302 are generally flush.

The annular cavity 220 of the insulated tubing member 202 is delimited by the outer surface 214 of the inner tubing 208, the inner surface 216 of the outer tubing 210, a downstream end surface 240 of the upstream fitting 204, inner and downstream surfaces of the downstream portion 306 of the upstream sleeve 300, the upstream end surface 274 of the downstream fitting 206 and inner and upstream surfaces of the upstream portion 216 of the downstream sleeve 302. The annular cavity 220 is sealed and filled with an insulating material in order to reduce heat loss from the inner tubing 208. In one example, the insulating material is a solid insulating material such as Insulfrax™, Aspen Aerogel Pyrogel XT™, or Cabot Nanogel™, for example. Alternatively, the annular cavity 220 may be filled with an inert gas, for example.

The upstream and downstream fittings 204, 206 are machined from steel, however, other suitable materials and manufacturing processes will be apparent to a person skilled in the art. The upstream and downstream sleeves 300, 302 may also be machined from steel or, alternatively, formed from sheet material, for example. Other suitable materials and manufacturing processes will be apparent to a person skilled in the art.

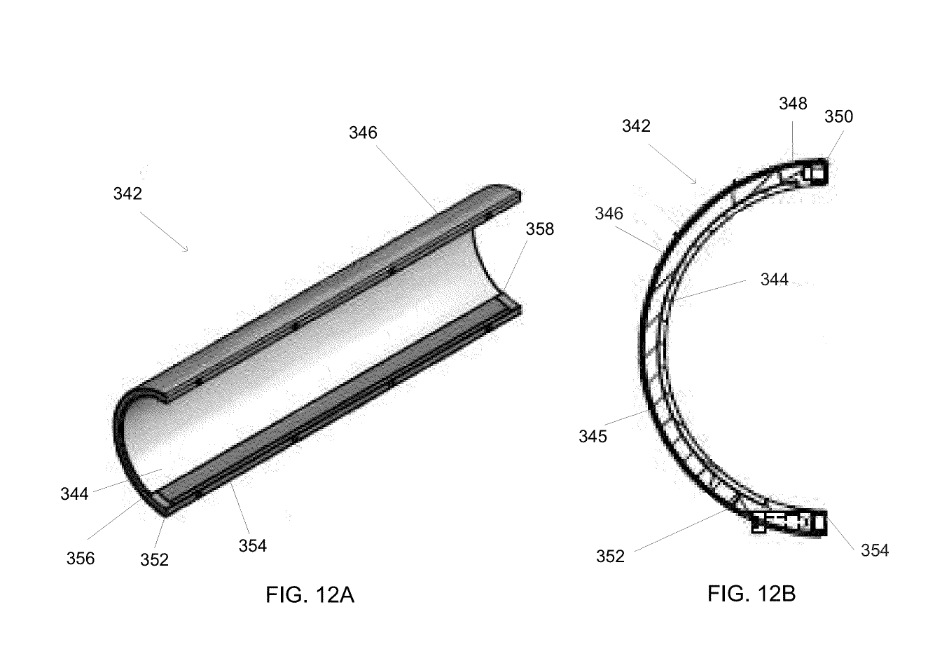

Referring back to FIGS. 6 and 7A, the joint cover 340 is assembled from a first joint cover sub-assembly 342, as shown in FIGS. 12A and 12B, that is coupled to a second joint cover sub-assembly 342. The joint cover sub-assembly 342 includes an inner cover 344 nested inside an outer cover 346 between a first insert 348, which is located adjacent a first inwardly extending flange 350 of the outer cover 346, and a second insert 352, which is located adjacent a second inwardly extending flange 354 of the outer cover 346. Joint cover ends 356, 358 are coupled to the outer cover 346 at opposite ends thereof and insulation 345 is located between the inner cover 344 and the outer cover 346.

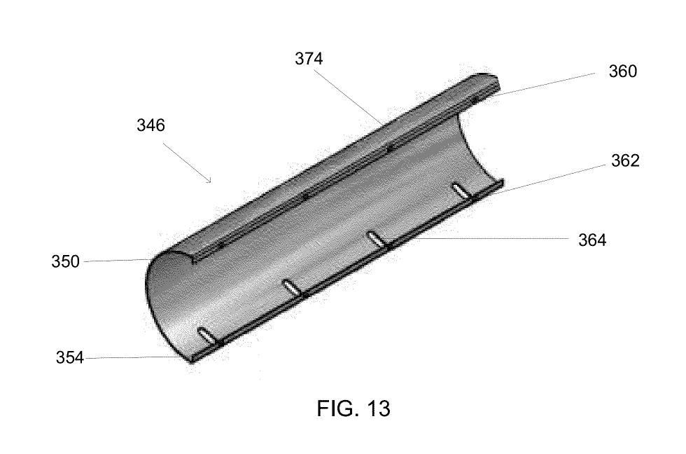

Referring to FIG. 13, the outer cover 346 includes first apertures 360 that extend through the first inwardly extending flange 350 and second apertures 362 that extend through the second inwardly extending flange 354. The first and second apertures 360 and 362 are evenly spaced along the respective inwardly extending flanges 350 and 354. In the embodiment shown, both the first inwardly extending flange 350 and the second inwardly extending flange 354 include four apertures. Openings 364 in the outer cover 346 are located adjacent to the second inwardly extending flange 354 and are aligned with the second apertures 362.

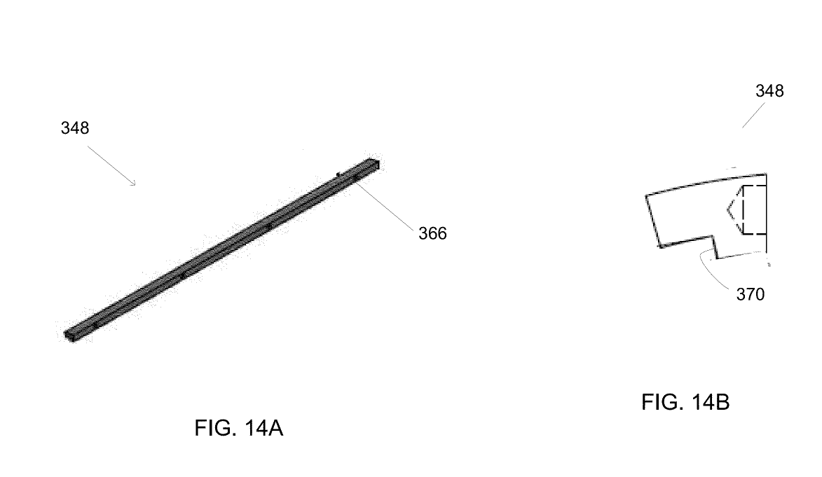

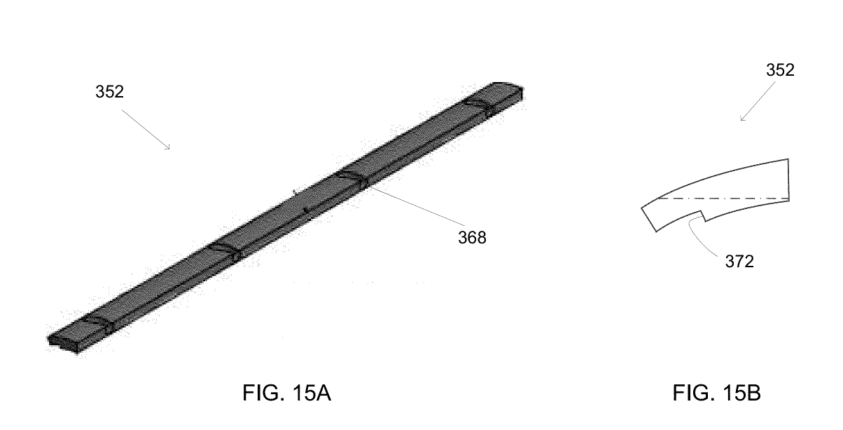

As shown in FIGS. 14A and 14B, the first insert 348 includes threaded apertures 366 for receiving fasteners, such as screws for example. As shown in FIGS. 15A and 15B, the second insert 352 includes apertures 368 that the fasteners pass through prior to entering threaded apertures 366 of the first insert 348. The first insert 348 and the second insert 352 include seats 370 and 372, respectively for receiving ends of the inner cover 344. The insulation 345 is provided in the cavity formed between the outer cover 346, the inner cover 344, the first insert 348, the second insert 352 and the Joint cover ends 356, 358. In one example, the insulation 345 is a solid insulating material such as Insulfrax™, Aspen Aerogel Pyrogel XT™, or Cabot Nanogel™, for example.

The inner cover 344, the first insert 348 and second insert 352 are made of Teflon®, for example. The inner cover 344, the first insert 348 and the second insert 352 may alternatively be made of other flexible materials having some insulating properties. The outer cover 346 is formed from steel, such as stainless steel, for example, or another suitable material.

In order to assemble the joint cover 340, fasteners secure the first inwardly extending flange 350 of a first sub-assembly 342 to the second inwardly extending flange 354 of a second sub-assembly 342. The fasteners are received through the openings 368 and generally do not protrude beyond an outer surface 374 of the outer cover 346.

In order to assemble the insulated tubing string, a selected number of insulated tubing members 202 are arranged end-to-end and upstream fittings 204 are coupled to adjacent downstream fittings 206. Together, the upstream fittings 204 and the downstream fittings 206 function as a coupling to join adjacent lengths of insulated tubing. The joint cover sub-assemblies 342 are placed over exposed portions of the upstream fittings 204 and the downstream fittings 206 and assembled to provide the joint covers 340. The outer diameter of the joint cover 340 is approximately the same as the outer diameter of the sleeves 300, 302 adjacent thereto and the joint cover 340 is sized to fit between the upstream and downstream sleeves 300, 302 so that the insulated tubing member 202 has a generally smooth and continuous outer surface along a length thereof. The joint covers 340 provide further insulation to the insulated tubing member 202 in order to reduce heat loss from the connection between the upstream and downstream fittings 204, 206. When used in a SAGD application, the insulated tubing string of FIGS. 6-15B is arranged in a similar manner as has been described with respect to the embodiment of FIGS. 1-5.

In operation, steam is injected into the insulated tubing string 100 in order to supply steam to a sand face of a well. The heat from the steam causes the inner tubing 208 of the insulated tubing members 202 to thermally expand. As the inner tubing 208 lengthens due to the thermal expansion, the downstream fittings 206 are pushed in a downstream direction and the outer surfaces 266 of the downstream fittings 206 slide relative to the inner surfaces 320 of the downstream sleeves 302. As such, the overall length of the insulated tubing string increases during operation and gaps are present between the downstream sleeves 302 and the joint covers 340. In one example, for an insulated tubing member having a 10 meter length, the gaps are approximately 32 mm. Following operation, when the insulated tubing string has cooled, the inner tubing 208 returns to a pre-expanded length.

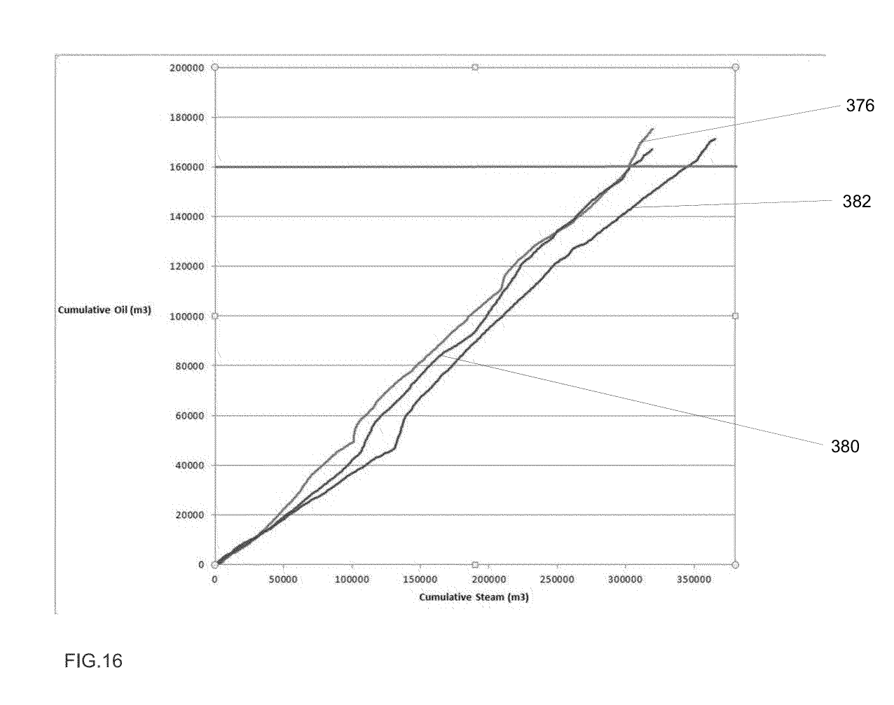

The insulated tubing strings including the insulated tubing members 102, 202 provide at least the following advantages over prior art tubing strings: heat losses may be reduced, outer tubing temperatures may decrease and Cumulative Steam Oil Ratio (CSOR) may be decreased. Further, because heat losses are reduced, higher quality steam may be delivered to the sand face because a higher mass of steam is present downhole. SAGD economics may be improved due to the reduced heat loss and emissions may be decreased as a result of the decreased CSOR. The graph of FIG. 16 compares an insulated tubing string including insulated tubing members 102 (line 376), a prior art insulated tubing string (line 380) and a non-insulated tubing string (line 382). It has been determined that insulated tubing strings including insulated tubing members 102 may decrease CSOR by 5-15% over non-insulated tubing. A decreased CSOR generally means that either more oil is being produced at a fixed steam rate or less steam is required at a fixed oil rate. Insulated tubing members 202 may provide further improved results due to the inclusion of the joint cover 340.

The insulated tubing members 102, 202 described herein produce CSOR results that are at least as good as the prior art insulated tubing but the insulated tubing 102, 202 may also be significantly more durable. Because the joint between the inner tubing and the outer tubing of the insulated tubing members 102, 202 is not fixed, stresses due to thermal expansion do not cause damage to the joint. Therefore, the insulated tubing members 102, 202 have a longer service life and are replaced less frequently than prior art insulated tubing members. By increasing the service life of the components, the long term cost may be much lower.

The insulated tubing members 102, 202 are not limited to the examples described herein. The insulated tubing members 102, 202 may include other slip joint arrangements to allow for differential thermal expansion between the inner tubing and the outer tubing. In addition, a joint cover, such as the example joint cover described herein, may be added to the insulating tubing member 102 and may further reduce heat loss.

Specific embodiments have been shown and described herein. Modifications and variations may occur to those skilled in the art. All such modifications and variations are believed to be within the scope and sphere of the present invention.

1. An insulated tubing member comprising:
an inner tubing received in an outer tubing, the inner tubing coupled to the outer tubing by an upstream fitting located at an upstream end of the insulated tubing member and a downstream fitting located at a downstream end of the insulated tubing member;
insulating material received in an annular cavity delimited by the inner tubing, the outer tubing, the upstream fitting and the downstream fitting;
a slip joint between the inner tubing and the outer tubing to allow for axial movement of the inner tubing relative to the outer tubing; and
wherein the axial movement is due to thermal expansion.

2. The insulated tubing member of claim 1, wherein the downstream fitting is slidable relative to the outer tubing.

3. The insulated tubing member of claim 1, wherein a downstream end of the upstream fitting is sandwiched between the inner tubing and the outer tubing.

4. The insulated tubing member of claim 1, wherein an upstream end of the downstream fitting is sandwiched between the inner tubing and the outer tubing.

5. The insulated tubing member of claim 1, wherein the annular cavity is delimited by an outer surface of the inner tubing, an inner surface of the outer tubing, a downstream end surface of the upstream fitting and an upstream end surface of the downstream fitting.

6. The insulated tubing member of claim 2, wherein a seal is provided between an outer surface of the downstream fitting and an inner surface of the outer tubing.

7. The insulated tubing member of claim 1, wherein the inner tubing and the outer tubing are coupled to the upstream fitting by respective threaded connections.

8. The insulated tubing member of claim 1, wherein the inner tubing is coupled to the downstream fitting by a threaded connection.

9. The insulated tubing member of claim 1, wherein the insulating material is a solid insulating material.

10. The insulated tubing member of claim 1, wherein the insulating material is at least one of: Insulfrax™, Aspen Aerogel Pyrogel XT™, or Cabot Nanogel™.

11. The insulated tubing member of claim 1, comprising a joint cover surrounding at least a portion of the downstream fitting and at least a portion of a downstream fitting of an adjacent insulating tubing member.

12. The insulated tubing member of claim 11, wherein the joint cover comprises insulation.

13. The insulated tubing member of claim 12, wherein the insulation is a solid insulating material.

14. The insulated tubing member of claim 13, wherein the insulation is at least one of: Insulfrax™, Aspen Aerogel Pyrogel XT™, or Cabot Nanogel™.

15. The insulated tubing member of claim 1, wherein an upstream sleeve is between the upstream fitting and the outer tubing.

16. The insulated tubing member of claim 1, wherein a downstream sleeve is between the downstream fitting and the outer tubing.

17. The insulated tubing member of claim 16, wherein the downstream fitting is slidable relative to the downstream sleeve.

18. The insulated tubing member of claim 17, wherein a seal is provided between an outer surface of the downstream fitting and an inner surface of the outer tubing.
